(19) United States
(12) Patent Application Publication
(10) Pub. No.: US 2007/0041128 A1
(43) Pub. Date: Feb. 22, 2007

(54) Head cleaning apparatus and magnetic recording and reproducing device having the same

(75) Inventor: Myoung-sub Jang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/360,762

(22) Filed: Feb. 24, 2006

(30) Foreign Application Priority Data
Aug. 18, 2005 (KR) 2005-0075883

(51) Int. Cl. G11B 5/41

(52) U.S. Cl. 360/128

(57) ABSTRACT

A head cleaning apparatus and a magnetic recording and reproducing device having the same are disclosed. The head cleaning apparatus includes a cleaning member for cleaning a head, a lever member for supporting and fixing the cleaning member, and for operating to bring the cleaning member into contact with the head by engaging a pole base assembly in a moving section of the pole base assembly during loading and unloading of a tape, and a fixing member for snap-fixing the lever member in a deck plate. The lever member of the head cleaning unit may be integrally formed with the fixing member as one component. The lever member may be snap-fixed at the deck plate by the fixing member. Accordingly, the number of separate molding steps required during manufacturing and the number of assembly processes are both decreased, thereby lowering manufacturing costs and increasing productivity.

### CROSS-REFERENCE TO RELATED APPLICATIONS

This application claims the benefit under 35 U.S.C. § 119(a) of Korean Patent Application No. 2005-75883, filed Aug. 18, 2005, in the Korean Intellectual Property Office, the entire contents of which are hereby incorporated by reference.

### BACKGROUND OF THE INVENTION

1. Field of the Invention

The present invention relates to a magnetic recording and reproducing device such as a VTR (Video Tape Recorder) or a camcorder. More particularly, the present invention relates to a head cleaning apparatus which is capable of cleaning a head, and a magnetic recording and reproducing device having the same.

2. Description of the Related Art

Generally, a magnetic recording and reproducing device such as a VTR (Video Tape Recorder) or a camcorder has a head that records or reproduces audio or video signals on a magnetic tape while the magnetic tape moves along a path.

The head may accumulate foreign substances, such as magnetic substances generated by abrasion of the magnetic tape when it is used for a long time. If the head is dirty, the head may have a shortened lifespan, and the recording and reproducing performance may deteriorate.

Accordingly, a typical magnetic recording and reproducing device has a head cleaning apparatus which is capable of cleaning the head during the loading and unloading of a magnetic tape, to prevent the head from being contaminated.

FIG. 1 shows a deck mechanism 1 of a magnetic recording and reproducing device having a conventional head cleaning apparatus.

The deck mechanism 1 includes a deck plate 10, a head drum assembly 2, first and second pole base assemblies 36, 37 and a head cleaning unit 3.

The head drum assembly 2 has a head drum 31 and a drum base 32. The head drum 31 includes a head that records or reproduces information by scanning a magnetic tape. The drum base 32 fixes the head drum 31 so that it is inclined at an angle with respect to the deck plate 10.

The first and second pole base assemblies 36, 37 guide the magnetic tape into contact with the head drum 31 when the magnetic tape is loaded or unloaded. The first and second pole base assemblies 36, 37 include first and second pole bases 36a, 37a, first and second slant poles 36b, 37b, and first and second guide rollers 36c, 37c. The first and second pole bases 36a, 37a extend into first and second guide grooves 39, 40, and slide along the first and second guide grooves 39, 40 when the magnetic tape is loaded or unloaded. The first and second slant poles 36b, 37b protrude from and are inclined with respect to the first and second pole bases 36a, 37a. The first and second guide rollers 36c, 37c regulate up and down movement of a magnetic tape when a magnetic tape is pressed against the first and second slant poles 36b, 37b during loading or unloading of the tape.

As illustrated in FIGS. 2 through 4, the head cleaning unit 3 cleans the head 33 of the head drum 31, and includes a fixing substrate 5, an operating piece 9, a pivoting lever 12, and a cleaning roller 19.

The fixing substrate 5 is fixed at the deck plate 10 by a screw 6, and has a shaft 7 and a first spring fixing piece 8.

An operating piece 9 is rotatably installed on the shaft 7, and the operating piece 9 has a first spring hook 24 and a protrusion hole 11.

The pivoting lever 12 is mounted at the protrusion hole 11 by a pivoting shaft 13 formed at a lower part of one side of the pivoting lever 12. A shaft 7 extends through the pivoting shaft 13, and a first stop ring 22 is fixed to an upper side of the shaft 7 to support the pivoting lever 12.

The pivoting lever 12 has a second spring hook 14 and a second spring fixing piece 15 formed at one side, and an upward roller shaft 16 protruding from a front end of the other side.

The protrusion hole 11 of the operating piece 9 has an elastic tension spring 17 disposed about the perimeter of the operating piece. One end of the tension spring 17 engages the first spring hook 24 of the operating piece 9 and the other end engages the second spring hook 14 of the pivoting lever 12. An extension spring 18 is installed between the first spring fixing piece 8 of the fixing substrate 5 and the second spring fixing piece 15 of the pivoting lever 12.

The cleaning roller 19 is rotatably disposed on the roller shaft 16 by a bushing 20. A fixed second stop ring 21 is disposed at an upper side of the roller shaft 16 to support the bushing 20.

The operation of the conventional deck mechanism 1 of a magnetic recording and reproducing device will now be described.

As illustrated by the dotted line in FIG. 1, when a cassette tape (C) arrives at a reel table for supply 45a and a reel table for winding 45b of the deck plate 10, and a loading motor 47 is driven, a tension arm 52 is pivoted counterclockwise by a tension arm driving device (not shown). Accordingly, a tension pole 53 pushes the magnetic tape (T) toward an impedance roller 54.

The first and second pole bases 36a, 37a of the first and second pole base assemblies 36, 37 move toward the head drum 31 along the first and second guide grooves 39, 40 of a guide rail 38 by a pole base driving device (not shown) which is driven by driving power transmitted from the loading motor 47. Accordingly, the first and second guide rollers 36c and 37c withdraw the magnetic tape (T) from the tape cassette (C) and press the tape into contact with the head drum 31.

As illustrated by the dotted line in FIG. 1, when the first pole base 36a of the first pole base assembly 36 reaches a position ‘A’, a lower part of the first guide roller 36c contacts the operating piece 9 and starts pushing it to the right. As the operating piece 9 is pushed into the right, the first spring hook 4 of the operating piece 9 rotates counterclockwise. As a result, the tension spring 17 that engages the first and second spring hooks 24, 14, provides a counterclockwise elastic force and rotates the pivoting lever 12 counterclockwise.

As the pivoting lever 12 rotates, the cleaning roller 19 contacts the head drum 31. At this state, the head drum 31 rotates and foreign substances are cleaned from the head 33.

Likewise, while the first pole base 36a of the first pole base assembly 36 moves from the position ‘A’ to the position ‘B’, the cleaning roller 19 cleans foreign substances from the head 33.

When the first pole base 36a reaches the position ‘C’, the first guide roller 36c escapes from the operating piece 9. As a result, the pivoting lever 12 rotates counterclockwise due to the force of the extension spring 18 and returns to its original position, and the cleaning roller 19 moves away from the head drum 31 and stops cleaning the head 33.

Information is recorded on and reproduced from the magnetic tape (T) by the head 33. If the loading motor 47 is driven in a reverse direction to unload the magnetic tape (T), the first and second pole bases 36a, 37a of the first and second pole base assemblies 36 and 37 move away from the head drum 31 by the pole base driving device to return to their initial position, and the tension arm 52 pivots clockwise by the tension arm driving device to separate the tension pole 53 from the impedance roller 54.

If the first guide roller 36a is located between the position B and the position A, the cleaning roller 19 contacts the head drum 31 to clean foreign substances from the head 33. When the first guide roller 36c moves away from the position A, the cleaning roller 19 moves away from the head drum 31, to stop cleaning the head 33.

As described, the deck mechanism 1 of the conventional magnetic recording and reproducing device cleans the head 33 by moving the cleaning roller 19 into contact with the head drum 31 or moving it away from the head drum, by use of the loading and unloading actions of the first pole base assembly 36.

The deck mechanism 1 of the conventional magnetic recording and reproducing device, however, has separate parts such as the fixing substrate 5, the operating piece 9, and the pivoting lever 9 which are engaged in the deck plate 10 by the screw 6.

Because separate metal patterns must be used to manufacture the fixing substrate 5, the operating piece 9, and the pivoting lever 12, which must then be assembled into a single unit, the manufacturing costs for the deck mechanism 1 of the conventional magnetic recording and reproducing device are increased, and manufacturing productivity is decreased. In addition, screws are needed to assemble each unit, which increases the number of required assembly processes.

Furthermore, in the typical deck mechanism 1 of the conventional magnetic recording and reproducing device, as illustrated in FIG. 1, a cable 60 is connected with the head drum 31. The cable 60 is formed on an operating section of the head cleaning unit 3 and the first pole base assembly 36. During operation, the head cleaning unit 3 and the first pole base assembly 36 may contact the cable 60, which may cause instability or malfunctions.

Accordingly, there is a need for an improved head cleaning device which is easier to manufacture, and which avoids entanglement of a cable connected with a head drum.

### SUMMARY OF THE INVENTION

An aspect of the present invention is to address at least the above problems and/or disadvantages and to provide at least the advantages described below. Accordingly, an aspect of the present invention is to provide a head cleaning apparatus and a magnetic recording and reproducing device having the same, which has a reduced number of parts, thereby allowing for simpler assembly and a more stable operation.

In accordance with an aspect of the present invention, a head cleaning apparatus and a magnetic recording and reproducing device having the same comprises a cleaning member for cleaning a head, a lever member for supporting and fixing the cleaning member, and for operating to bring the cleaning member into contact with the head by contacting a pole base assembly in a moving section of the pole base assembly during loading and unloading of a tape, and a fixing member for snap-fixing the lever member in a deck plate.

The lever member may include an angular movement lever that moves to bring the cleaning member into contact with the head; and an angular movement operating part that protrudes toward a movement path of the pole base assembly to engage the pole base assembly during movement of the pole base assembly.

The fixing member may include a body connected with the lever member, a first hook formed on the body, the first hook adapted to be locked in a fixing hole formed on the deck plate, and a supporting part formed on the body, the supporting part adapted to be inserted in the fixing hole together with the first hook to prevent the first hook from escaping from the fixing hole.

The first hook may be locked to one edge of the fixing hole, and the supporting part may include at least one protrusion formed to contact the opposite edge of the fixing hole.

The fixing member may include a second hook formed on the body, the second hook adapted to be locked in a cable hole formed in the deck plate.

The head cleaning apparatus of the present invention may further comprise a cable guide disposed on the body for guiding a cable withdrawn through the cable hole formed in the deck plate and connected with a head drum so that the cable does not contact the cleaning member, the lever member, or the pole base assembly, and become interrupted. The cable guide may comprise a substantially vertical member, to facilitate withdrawal of the cable from the cable hole and connect the cable with the head drum.

According to another exemplary embodiment of the present invention, a magnetic recording and reproducing device comprises a head drum having a head that records and reproduces information on and from a tape; at least one pole base assembly that loads or unloads a tape with respect to the head drum, a deck plate having a guide rail for guiding movement of the pole base assembly, and a head cleaning unit for cleaning the head. The head cleaning unit may comprise a cleaning member for cleaning a head, a lever member for supporting and fixing the cleaning member, and for operating to bring the cleaning member into contact with the head by contacting a pole base assembly in a moving section of the pole base assembly during loading and unloading of a tape, and a fixing member for snap-fixing the lever member in a deck plate.

The lever member may include an angular movement lever that moves to bring the cleaning member into contact with the head; and an angular movement operating part that protrudes toward a movement path of the pole base assembly to engage the pole base assembly during movement of the pole base assembly.

The fixing member may include a body connected with the lever member, a first hook formed on the body, the first hook adapted to be locked in a fixing hole formed on the deck plate, and a supporting part formed on the body, the supporting part adapted to be inserted in the fixing hole together with the first hook to prevent the first hook from escaping from the fixing hole.

The first hook may be locked to one edge of the fixing hole, and the supporting part may include at least one protrusion formed to contact the opposite edge of the fixing hole.

The fixing member may include a second hook formed on the body, the second hook adapted to be locked in a cable hole formed in the deck plate.

The head cleaning apparatus of the present invention may further comprise a cable guide disposed on the body for guiding a cable withdrawn through the cable hole formed in the deck plate and connected with a head drum so that the cable does not contact the cleaning member, the lever member, or the pole base assembly, and become interrupted. The cable guide may comprise a substantially vertical member, to facilitate withdrawal of the cable from the cable hole and connect the cable with the head drum.

According to another exemplary embodiment of the present invention, a head cleaning apparatus for a magnetic recording and reproducing device comprises a cleaning member for cleaning a head, means for supporting the cleaning member and engaging the pole base assembly to bring the cleaning member into contact with the head as the pole base assembly moves to load and unload a tape, and means for snap-fixing the means for supporting the cleaning member into a deck plate.

The means for supporting the cleaning member may comprise a lever member comprising an angular movement lever that bring the cleaning member into contact with the head.

The angular movement lever may comprise an elastic, V-shaped member.

The lever member may further comprise an angular movement operating part that engages the pole base assembly during movement of the pole base assembly.

The means for snap-fixing the means for supporting the cleaning member into a deck plate may comprise a body integrally formed with the lever member, a first hook formed on the body, the first hook adapted to be locked into a fixing hole in the deck plate, and means for preventing the first hook from escaping from the fixing hole.

The means for snap-fixing the means for supporting the cleaning member into a deck plate may further comprise a second hook formed on the body, the second hook adapted to be locked into a cable hole formed in the deck plate.

### BRIEF DESCRIPTION OF THE DRAWING FIGURES

The above and other objects, features, and advantages of certain exemplary embodiments of the present invention will be more apparent from the following description take in conjunction with the accompanying drawings, in which:

FIG. 1 is a plan view of a deck mechanism of a conventional magnetic recording and reproducing device;

FIG. 2 is a perspective view of a head cleaning unit of the deck mechanism of FIG. 1;

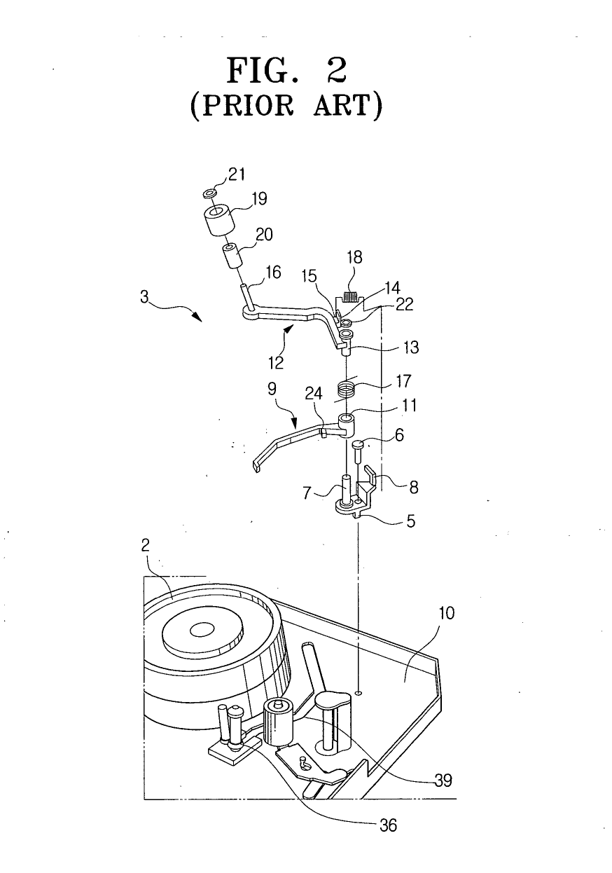

FIG. 3 is a plan view of the head cleaning unit of the deck mechanism of FIG. 1;

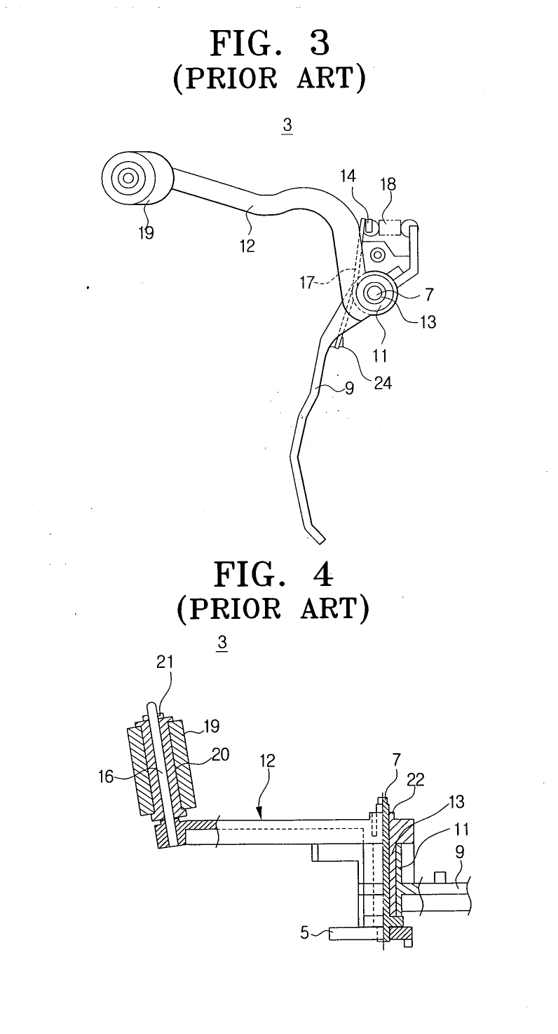

FIG. 4 is a sectional side elevational view of the head cleaning unit of the deck mechanism of FIG. 1;

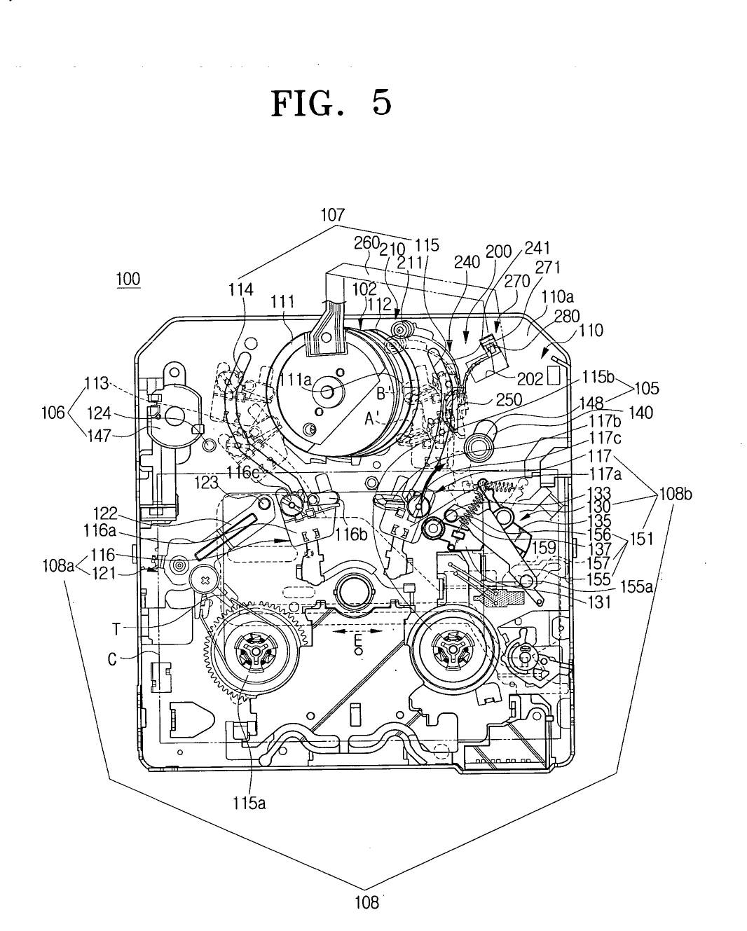

FIG. 5 is a plan view of a deck mechanism of a magnetic recording and reproducing device according to an exemplary embodiment of the present invention;

FIGS. 6A, 6B and 6C are a partial perspective views of a head cleaning unit of the deck mechanism in FIG. 5;

FIG. 7 is a partial perspective view of a fixing member of the head cleaning unit of the deck mechanism illustrated in FIG. 5;

FIG. 8 is a partial perspective view of the fixing member of the head cleaning unit of the deck mechanism illustrated in FIG. 5 affixed to a deck of the deck mechanism illustrated in FIG. 5; and

FIG. 9 is a plan view of the deck mechanism illustrated in FIG. 5, after a tape has been loaded.

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

According to an exemplary embodiment of the present invention, a magnetic recording and reproducing device having a head cleaning apparatus includes a deck mechanism for recording audio and visual signals on; and reproducing audio and visual signals from, a magnetic tape by moving the magnetic tape along a travel path.

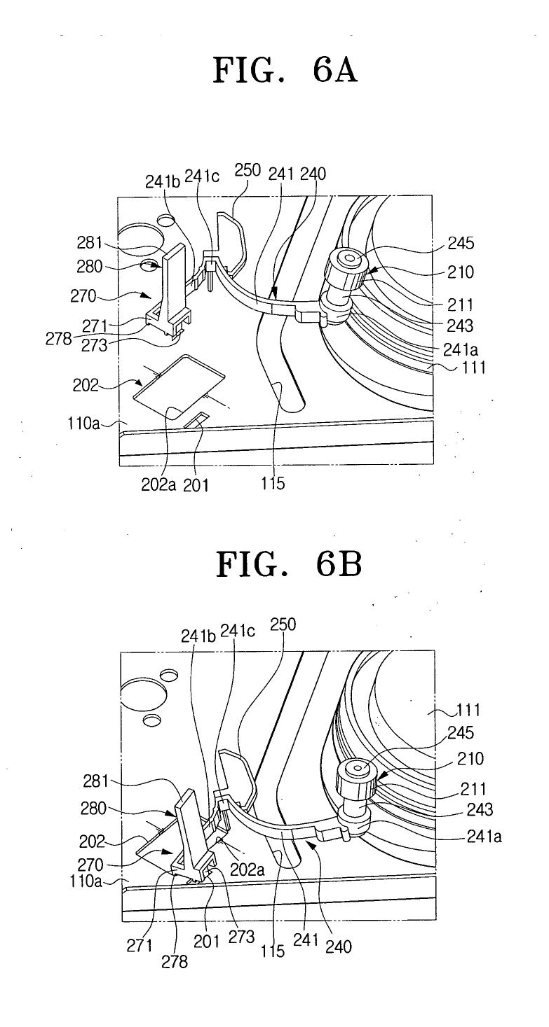

FIG. 5 shows the deck mechanism 100 of the magnetic recording and reproducing device having the head cleaning apparatus. The deck mechanism 100 includes a deck plate 110, a head drum assembly 102, a head cleaning unit 200, a traveling driving unit 105 for transporting the magnetic tape (T), a tape traveling guide unit 108 for guiding the magnetic tape (T) traveling on the deck plate 110 by driving the traveling driving unit 105, and a loading driving unit for moving each component of the tape traveling guide unit 108 during loading and unloading of the magnetic tape (T).

The deck plate 110 includes a chassis 110a. The head drum assembly 102 is, in the exemplary embodiment, formed at the center of one of the chassis 110a, that is, the center of the upper side of the FIG. 5.

The head drum assembly 102 has a head drum 111 that includes a head 111a for scanning a magnetic tape to record or reproduce audio and visual information, and a drum base 112 for fixing the head drum 111 to the chassis 110a. The head drum 111 may be attached with a screw at a predetermined angle with respect to the chassis 110a.

The head cleaning unit 200 includes a cleaning member 210, a lever member 240, and a fixing member 270.

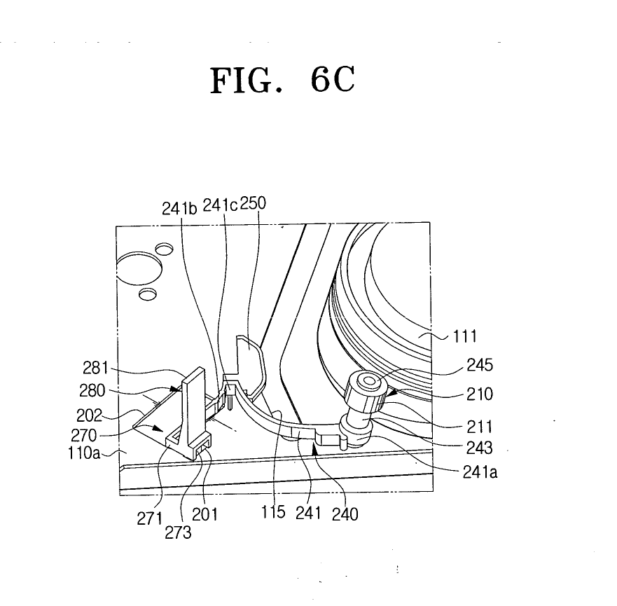

The cleaning member 210 cleans the head 111a, and includes a cleaning roller 211. The cleaning roller 211 is rotatably disposed at a bushing (not shown) of a roller shaft 243 protruding from a first part 241a of an angular movement lever 241 (referring to FIG. 6A) of a lever member 240 (which will be described in detail below). A stop ring 245 supports the cleaning roller 211 on the upper side of the roller shaft 243.

The lever member 240 makes an angular movement which moves the cleaning roller 211 from the first position (indicated by the solid lines in FIG. 5) to the second position (indicated by the dotted lines in FIG. 5) by engaging the lower part of a first guide roller 117c of a first pole base assembly 117 in a predetermined moving section (that is, between a position A′ and a position B′) of the first pole base assembly 117, during loading and unloading of the magnetic tape (T). The lever member 240 includes the angular movement lever 241 and an angular operating piece 250. The first position is a non-cleaning area (the solid line of FIG. 5) where the cleaning roller 211 does not contact the head 111a of the head drum 111, while the second position is a cleaning area where the cleaning roller 211 contacts the head 111a.

As illustrated in FIGS. 6A through 6C, the angular movement lever 241 is curved, for example, V-shaped, and is elastic. The angular lever 241 includes a first part 241a, a second part 241b, and a connecting part 241c. A roller shaft 243 protrudes at an angle from the front end of the first part 241a. The second part 241b is connected with the front end of the fixing member 270. The connecting part 241c connects the first part 241a and the second part 241b.

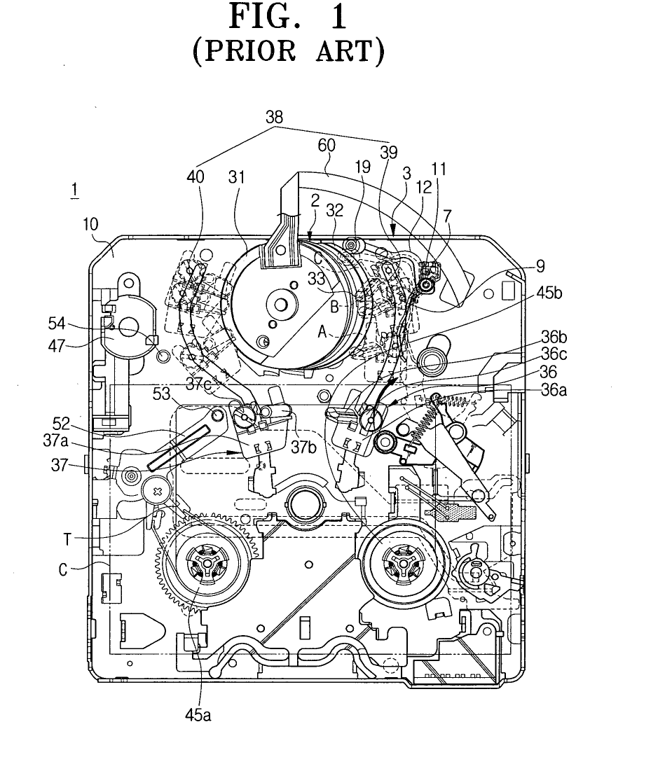

The angular movement operating piece 250 is disposed on the lower part of the connecting part 241c of the angular movement lever 241, and protrudes toward the movement path of the first guide roller 117c in a moving section of the first pole base assembly 117, that is a section between the position A′ to the position B′. Accordingly, the angular movement operating piece 250 is pushed by the lower part of the first guide roller 117c, when the first pole base assembly 117 is located in the section between the position A′ to the position B′, as illustrated in a dotted line in FIG. 1, during loading and unloading of the magnetic tape (T). As a result, the angular movement lever 240, which is connected to the angular movement operating piece 250, moves the cleaning roller 211 from the first position (the solid line of FIG. 5) to the second position (the dotted line).

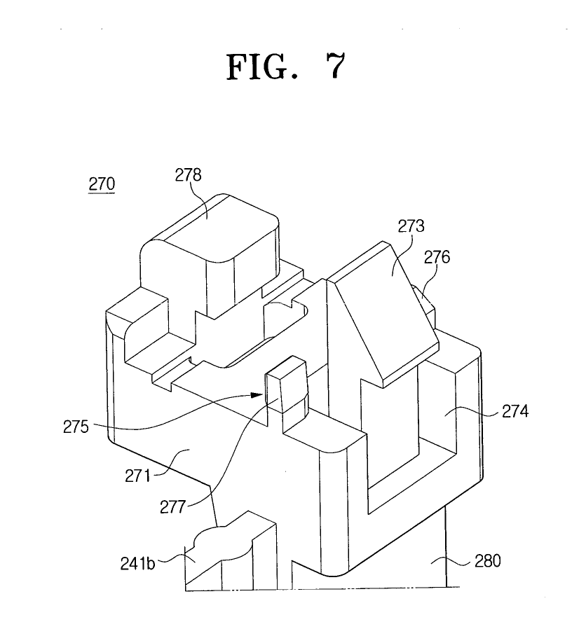

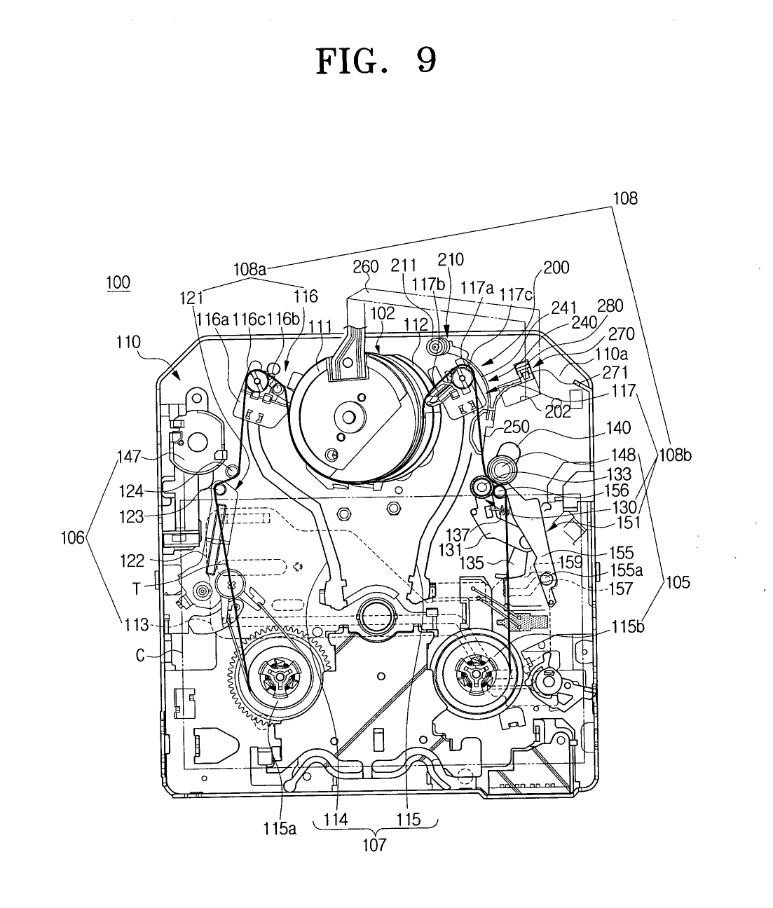

As illustrated in FIGS. 7 and 9, the fixing member 270 snap-fixes the lever member 240 at the chassis 110a of the deck plate 110, and includes a body 271, a first hook 273 and a supporting part 275.

The body 271 is integrally formed with the second part 241b of the angular movement lever 241. A recess part 274 is disposed on one end of the lower part of the body 271. A first hook 273 protrudes from the recess part 274, and is locked in a fixing hole 201 adjacent to a cable hole 202 on the chassis 1110a of the deck plate 110. The first hook 273 is elastically formed so that it may be easily locked into the fixing hole 201.

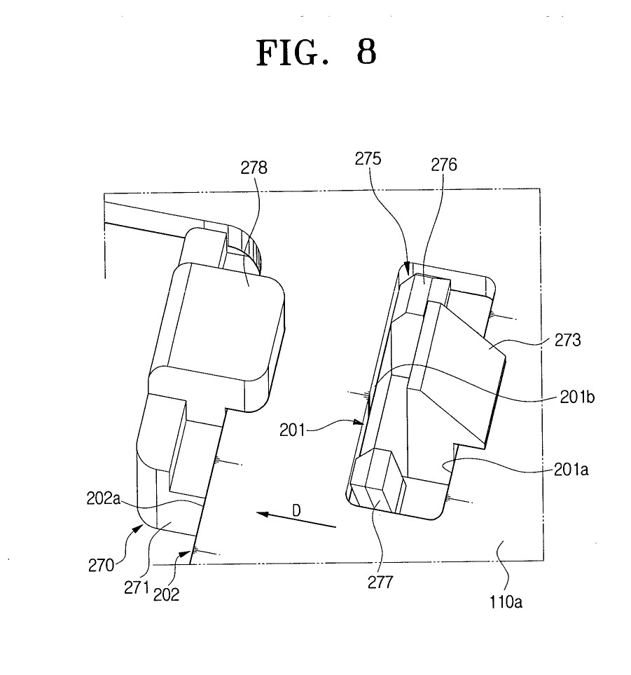

A supporting part 275 including, for example, first and second protrusions 276, 277 is disposed on the lower part of the body 271 around the recess part 274. As illustrated in FIG. 8, the first hook 273 contacts one edge 201a of the fixing hole 201, and the first and second protrusions contact the opposite edge 201b. Accordingly, when the first and second protrusions 276, 277 are inserted into the fixing hole 201 with the first hook 273, the body 271 can not be moved in the direction of the arrow (D) due to the first and second protrusions 276, 277, even if force is applied to the body direction of the arrow (D). Accordingly, the first hook 273 is fixed into the fixing hole 201.

The fixing member 270 may further include a second hook 278 that protrudes from the other lower side of the body 271, in order to more firmly fix the body 271 to the chassis 110a. The second hook 278 is locked at one side edge 202a of a cable hole 202 formed on the chassis 110a. The second hook 278 more firmly fixes the body 271 at the chassis 110a and fixes the body 271 into the cable hole 202 before the first hook 273 is locked in the fixing hole 201. Accordingly, the first hook 273 is easily locked in the fixing hole 201, during assembly.

The assembly of the head cleaning unit 200 to the chassis 110a will now be described in more detail.

As illustrated in FIG. 6A, the head cleaning unit 200 is placed at the chassis 110a, so that the first and second hooks 273, 278 of the fixing member 270 are located above the fixing hole 201 and the cable hole 202.

As illustrated in FIG. 6B, the head cleaning unit 200 is moved down, and the second hook 278 is inserted into the cable hole 202 around the edge 202a.

As illustrated in FIG. 6C, the head cleaning unit 200 is pushed down so that the first hook 273, and the first and second hooks 276, 277 of the supporting part 275 are inserted in the fixing hole 201. As a result, the first hook 273 is locked in the fixing hole 201. The engagement of the second hook 278 with the side edge 202a of the cable hole 202, allows the first hook 273 to be easily locked into the fixing hole 201.

Referring to FIG. 5 again, the head cleaning unit 200 may further comprise a cable guide 280 for guiding a cable 260 so that when the cable 260 is withdrawn through the cable hole 202 and connected to a connection terminal of the head drum 111, it does not contact the cleaning member 210, the lever member 240, or the first pole base assembly 117, which may cause a disruption in the connection.

As illustrated in FIGS. 6A through 6C, the cable guide 280 is formed with a protruding, substantially vertical member 281 to withdraw the cable 260 in a generally vertical direction from the cable hole 202 and connect the cable 260 to the connection terminal of the head drum 111.

The traveling driving unit 105 has a capstan shaft 148 which is rotated by a capstan motor 140. The capstan motor 140 also drives a reel table for supplying 115a and a reel table for winding 115b, which are used to drive tape reels of a cassette tape (C) seated in the deck mechanism. The capstan motor 140 supplies the driving force for driving the reel table for supplying 115a and the reel table for winding 115b through a power transmitting gear train (not shown). The power transmitting gear train is well-known to those skilled in the art. Accordingly, for conciseness, it will not be described in detail.

The loading driving unit 106 has a loading motor 147 formed in the chassis 110, and a main slide member 113 formed in the chassis 10a to be slid back and forth in the direction of the arrow (E) by a slide member driving device (not shown) driven by a driving force transmitted from the loading motor 147. The slide member driving device is well-known to those skilled in the art. Accordingly, for conciseness, it will not be described in detail.

The main slide member 113 has a guide protrusion 159 and a guide groove 157. The guide protrusion 159 is linked with a lower part of a pressure lever 135 of a pinch roller assembly 130 of a tape traveling guide unit 108, and the guide groove 157 is linked with an engagement protrusion 155a of a review arm 155 of a review pole assembly 151, during loading and unloading of a magnetic tape (T).

The tape traveling guide unit 108 has a supply reel guide device 108a and a winding reel guide device 108b, and includes a fixing pole member and a plurality of rollers for moving for the magnetic tape (T) to be located at a predetermined position inside the chassis 10a during loading and unloading of the magnetic tape (T).

The supply reel table guide device 108a has a tension pole assembly 121 and a second pole base assembly 116.

The tension pole assembly 121 includes a tension arm 122 pivotally disposed on the chassis 110a, a first tension pole 123 that vertically protrudes from the front end of the tension arm 122, and a fixing pole or impedance roller 124 fixed in the chassis 110a.

The tension arm 122 is pivoted to the position illustrated on FIG. 5 or FIG. 9 by the tension arm driving device (not shown) which receives a driving force from the loading motor 147 during loading and unloading of the magnetic tape (T). The tension arm driving device is well-known to those skilled in the art, so a detailed description is omitted for clarity and conciseness.

The tension pole 123 pulls the magnetic tape (T) toward the left of the chassis 110a to apply a predetermined tension to the magnetic tape (T). The impedance roller 124 regulates up and down movement of the magnetic tape (T) traveling via the tension pole 123.

The second pole base assembly 116 has a second pole base 116a, a second slant pole 116b, and a second guide roller 116c; The second pole base 116a is slid along a second guide groove 114 of a guide rail 107 by a pole base driving device (not shown), which is driven by power transmitted from the loading motor 147 during loading and unloading of the magnetic tape (T). The second slant pole 116b protrudes at a predetermined angle with respect to the second pole base 116a, and the second guide roller 116c regulates the up and down movement of the magnetic tape (T) entering into the second slant pole 16b.

The second pole base 116c is formed with two second guide bosses (not shown) on the lower part. The second guide bosses are inserted into and guided by the second guide groove 114.

The winding reel table guide device 108b comprises a review pole assembly 151, a first pole base assembly 117, and a pinch roller assembly 130.

The review pole assembly 151 comprises a review arm 155 which is pivotally disposed on the chassis 10a, and a review pole 156 that vertically protrudes from the front end of the review arm 155.

The review arm 155 has an engagement protrusion 155a which is engaged with the guide groove 157 of the main slide member 113 to be linked with the main slide member 113 during loading and unloading of the magnetic tape (T). The review arm 155 applies a predetermined tension to the magnetic tape (T) by pulling the magnetic tape (T) toward the right of the chassis 110a.

The first pole base assembly 117 is essentially symmetrical to the second pole base assembly 116, and has the same construction as the second pole base assembly 116.

That is, as illustrated in FIG. 5, the first pole base assembly 117 includes a first pole base 117a which slides along a first guide groove 115 of the guide rail 107 during loading and unloading of the magnetic tape (T), a first slant pole 117b that protrudes at a predetermined angle with respect to the first pole base 117a, and a first guide roller 117c that regulates up and down movement of the magnetic tape (T) that enters into the first slant pole 117b.

The lower part of the first pole base 117a is formed with two first guide bosses (not shown), and the first guide bosses are inserted into and guided by the first guide groove 115 of the guide rail 107.

The pinch roller assembly 130 has a pinch roller arm 131 pivotally disposed on the chassis 110a, a pinch roller 133 rotatably disposed at the end of the pinch roller arm 131, a pressure lever 135 that pivots about a pivotal shaft of the pinch roller arm 131, and a tension spring 137 that connects the pressure lever 135 and the pinch roller arm 131.

The first and second guide grooves 115, 114 of the guide rail 107 are formed in opposite directions from the first and second guide bosses, respectively, to house the first and second guide bosses of the first and second pole base assemblies 117, 116, respectively and guide the entire moving path of the first and second pole base assemblies 117, 116.

Referring to FIGS. 5 through 9, the operation of loading and unloading a tape with the deck mechanism 100 of the magnetic recording and reproducing device will now be described.

Initially, for the tape to be loaded, the tape cassette (C), as illustrated with a dotted line in FIG. 5, is seated in a reel table for supply 115a and a reel table for winding 115a, and a loading motor 147 is driven. The tension arm 122 is pivoted counterclockwise by a tension arm driving device. As a result, as illustrated in FIG. 9, the tension pole 123 pushes the magnetic tape (T) towards the impedance roller 124. The first and second pole bases 117a, 116a of the first and second pole base assemblies 117, 116, respectively, are moved toward the head drum 111 along the first and second guide grooves 115, 114 of the guide rail 107 by the pole base driving device (which is driven by a driving force transmitted from the loading motor 147). The first and second guide rollers 117c, 116c withdraw the magnetic tape (T) from the tape cassette (C) and move the tape (T) toward the head drum 111.

When the first pole base reaches the position A′, the lower part of the first guide roller 117c starts pushing the angular movement operating piece 250. As the angular movement operating piece 250 is pushed, the second part 241b is pushed, so that the angular movement lever 241 makes an angular movement, to move the cleaning roller 211 from the first position (the solid line of FIG. 5) to the second position (the dotted line of FIG. 5).

As a result, the cleaning roller 211 contacts the head drum 111. At this state, the head drum 111 rotates and foreign substances are cleaned from the head 11a.

While the first pole base 117a moves from the position A′ to a position B′, the cleaning roller 211 maintains contact with the head 111a and cleans foreign substances from the head 111a.

When the first pole base 117a reaches the state illustrated in FIG. 9, the lower part of the first guide roller 1117c escapes from the angular movement operating piece 250. As a result, the angular movement lever 241 returns to its original state due to the elasticity of the second part 241b, and the cleaning roller 211 moves away from the head drum 111, to stop cleaning the head 111a.

The main slide member 113 is driven by the slide member driving device in the direction of the arrow (E), and accordingly a guide protrusion 159 of the main slide member 113 pushes a lower part of a pressure lever 135 to the left. As a result, the pressure lever 135 rotates clockwise and the extension spring 137 extends. The pinch roller 133 contacts the capstan shaft 148 by the tension force of the extension spring 137.

The review arm 155 is pivoted clockwise by a guide groove 157 of the main slide member 113, and accordingly the review pole 156 pulls the magnetic tape to the right of the chassis 110a, to apply a predetermined the tension force to the magnetic tape (T).

While the magnetic tape (T) is loaded where illustrated in FIG. 9, the capstan motor 140 drives a reel table for supply 115a and a reel table for winding 115b through a power transmission gear train, and performs recording and reproducing, fast forward and rewind functions, and similar functions of winding or rewinding the magnetic tape (T) on a tape reel of the cassette (C).

For the magnetic tape (T) to be unloaded, the deck mechanism operates in a reverse order, and accordingly the tension pole 123, the first and second guide rollers 117c, 116c, the pinch roller 133, and the review pole 156 return to the position illustrated in FIG. 5.

When the first guide roller 117c is located between the position B′ and the position A′, together with the first pole base 117a, the cleaning roller 211 contacts the head drum 111 and cleans foreign substances from the head 111a. When the first guide roller 117c moves away from the position A′, the cleaning roller 211 moves away from the head drum 111 and stops cleaning the head 111a.

As described above, according to an exemplary embodiment of the present invention, a deck mechanism of a magnetic recording and reproducing device 100 has a lever member 240 of a head cleaning unit 200 integrally formed with a fixing member 270. The lever member 240 is snap-fixed at a chassis 110a of a deck plate 110 by the fixing member 270. Accordingly, the number of separate molding steps required during manufacturing and the number of assembly processes are both decreased, thereby lowering manufacturing costs and increasing productivity.

Furthermore, according to the exemplary embodiment of the present invention, the deck mechanism of the magnetic recording and reproducing device 100 is configured so that a cable withdrawn from a cable hole 202 of the chassis 110a and connected to a head drum 111, is vertically guided so that it avoids contacting the first pole base assembly 117 and the head cleaning unit 200 linked with the cable. Accordingly, during loading and unloading of a magnetic tape (T), the first pole base assembly 117 and the head cleaning unit are mechanically stable.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A head cleaning apparatus of a magnetic recording and reproducing device comprising:
a cleaning member for cleaning a head;
a pole base assembly;
a lever member that supports the cleaning member and engages the pole base assembly to bring the cleaning member into contact with the head as the pole base assembly moves to at least one of load and unload a tape; and
a fixing member that snap-fixes the lever member to a deck plate.

2. The head cleaning apparatus of a magnetic recording and reproducing device of claim 1, wherein the lever member comprises:
an angular movement lever that moves to bring the cleaning member into contact with the head; and
an angular movement operating part that protrudes toward a movement path of the pole base assembly to engage the pole base assembly during movement of the pole base assembly.

3. The head cleaning apparatus of a magnetic recording and reproducing device of claim 1, wherein the fixing member comprises:
a body connected with the lever member, the body comprising:
a first hook formed on the body, the first hook adapted to be locked in a fixing hole formed on the deck plate; and
a supporting part adapted to be inserted in the fixing hole together with the first hook to prevent the first hook from escaping from the fixing hole.

4. The head cleaning apparatus of a magnetic recording and reproducing device of claim 3, wherein the supporting part further comprises
at least one protrusion contacting an opposite edge of an edge of the fixing hole where the first hook is locked.

5. The head cleaning apparatus of a magnetic recording and reproducing device of claim 3, wherein the body of the fixing member comprises
a second hook adapted to be locked in a cable hole formed in the deck plate.

6. The head cleaning apparatus of a magnetic recording and reproducing device of claim 3, further comprising:
a cable guide disposed on the body for guiding a cable withdrawn through the cable hole formed in the deck plate and connected with a head drum.

7. The head cleaning apparatus of a magnetic recording and reproducing device of claim 6, wherein
the cable guide comprises a substantially vertical member to withdraw the cable from the cable hole and connect the cable with the head drum.

8. A magnetic recording and reproducing device comprising:
a head drum having a head that records and reproduces information on and from a tape;
at least one pole base assembly for loading or unloading a tape with respect to the head drum;
a deck plate having a guide rail for guiding movement of the pole base assembly; and
a head cleaning unit for cleaning the head, the head cleaning unit comprising:
a cleaning member for cleaning the head;
a lever member that supports the cleaning member and engages the pole base assembly to bring the cleaning member into contact with the head as the pole base assembly moves to at least one of load and unload a tape; and
a fixing member that snap-fixes the lever member to a deck plate.

9. The magnetic recording and reproducing device of claim 8, wherein the lever member comprises:
an angular movement lever that moves to bring the cleaning member into contact with the head; and
an angular movement operating part that protrudes toward a movement path of the pole base assembly to engage the pole base assembly during movement of the pole base assembly.

10. The magnetic recording and reproducing device of claim 8, wherein the fixing member comprises:
a body connected with the lever member, the body comprising:
a first hook adapted to be locked in a fixing hole formed on the deck plate; and
a supporting part adapted to be inserted in the fixing hole together with the first hook to prevent the first hook from escaping from the fixing hole.

11. The magnetic recording and reproducing device of claim 10, wherein the supporting part further comprises
at least one protrusion contacting an opposite edge of an edge of the fixing hole where the first hook is locked.

12. The magnetic recording and reproducing device of claim 10, wherein body of the fixing member comprises
a second hook adapted to be locked in a cable hole formed in the deck plate.

13. The magnetic recording and reproducing device of claim 10, further comprising:
a cable guide disposed on the body for guiding a cable withdrawn through the cable hole formed in the deck plate and connected with a head drum.

14. The magnetic recording and reproducing device of claim 13, wherein
the cable guide comprises a substantially vertical member to withdraw the cable from the cable hole and connect the cable with the head drum.

15. A head cleaning apparatus for a magnetic recording and reproducing device comprising:
a cleaning member for cleaning a head;
a pole base assembly;
means for supporting the cleaning member and engaging the pole base assembly to bring the cleaning member into contact with the head as the pole base assembly moves to load and unload a tape; and
means for snap-fixing the means for supporting the cleaning member into a deck plate.

16. The head cleaning apparatus of claim 15, wherein the means for supporting the cleaning member comprises:
a lever member comprising an angular movement lever that bring the cleaning member into contact with the head.

17. The head cleaning apparatus of claim 16, wherein
the angular movement lever comprises an elastic, V-shaped member.

18. The head cleaning apparatus of claim 17, wherein
the lever member further comprises an angular movement operating part that engages the pole base assembly during movement of the pole base assembly.

19. The head cleaning apparatus of claim 16, wherein the means for snap-fixing the means for supporting the cleaning member into a deck plate comprises:
a body integrally formed with the lever member, the body comprising:
a first hook adapted to be locked into a fixing hole in the deck plate; and
means for preventing the first hook from escaping from the fixing hole.

20. The head cleaning apparatus of claim 19, wherein the body further comprises a second hook adapted to be locked into a cable hole formed in the deck plate.
